(19) United States
(12) Patent Application Publication
(10) Pub. No.: US 2009/0067101 A1
(43) Pub. Date: Mar. 12, 2009

(54) Method and System for Limiting a Current in an Alternating Current Generator

(75) Inventor: Robert J. Nelson, Orlando, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS POWER GENERATION, INC., Orlando, FL (US)

(21) Appl. No.: 11/850,951

(22) Filed: Sep. 6, 2007

(51) Int. Cl. H02H 7/00; B23P 11/00

(52) U.S. Cl. 361/19; 29/428

(57) ABSTRACT

A method of connecting a superconducting fault current limiter to an alternating current generator to limit a current flowing in the generator is disclosed. A superconducting fault current limiter is connected in proximity with the generator to limit the current flowing in the generator. A system comprising a superconducting fault current limiter, a generator and a circuit is also disclosed.

### FIELD OF THE INVENTION

The present invention relates to a method and system for limiting a current in an electrical generating system and, more particularly, to a method of connecting a superconducting fault current limiter with an alternating current generator to limit a current in the generator.

### BACKGROUND OF THE INVENTION

Superconducting fault current limiters are known to be able to limit a current upon occurrence of a fault condition while introducing essentially zero impedance into the circuit during normal operation. These devices normally operate with a very low impedance and are transparent to an electrical circuit below a threshold current. Upon occurrence of a fault condition, the current rapidly increases above the threshold current causing the superconductor to stop superconducting forcing the current through a higher impedance parallel path thereby limiting the fault current to a predetermined value.

The discovery of so-called high temperature superconductors that can be cooled with liquid nitrogen rather than the more expensive and difficult to handle liquid helium has led to the development of relatively inexpensive high temperature superconducting fault current limiters. The use of these devices to limit fault currents in utility power transmission and distribution networks is attractive due to the lack of undesirable effects upon the network during normal operation.

### SUMMARY OF THE INVENTION

In accordance with a first aspect of the present invention, a method of limiting a current in an electrical generating system is provided. The method may comprise connecting an alternating current generator between an alternating current load and an earth conductor, connecting a superconducting fault current limiter between the alternating current generator and one of the alternating current load or the earth conductor, wherein the superconducting fault current limiter may be positioned proximate to the alternating current generator, and configuring the superconducting fault current limiter to limit the current in the alternating current generator to a predetermined maximum current.

In accordance with a second aspect of the present invention, a system to limit a current in an electrical generating system is provided. The system may comprise an alternating current generator, a superconducting fault current limiter and a circuit. The superconducting fault current limiter may be positioned proximate to the alternating current generator and may be between the alternating current generator and one of an alternating current load or an earth conductor and the superconducting fault current limiter may be configured to limit the current in the alternating current generator to a predetermined maximum current.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a side view of a three phase alternating current generator for use in a power generating station showing line connections, load connections and a stator assembly and rotor assembly in cut away;

FIG. 2 is a schematic representation of an aspect of the present invention showing a three phase superconducting fault current limiter connected in series with the neutral conductors of a three phase alternating current generator;

FIG. 3 is a schematic representation of another aspect of the present invention showing a three phase superconducting fault current limiter connected in series with a three phase alternating current generator and a three phase alternating current load between the main conductors of the generator and a three phase transformer connected to a three phase transmission and distribution network; and

FIG. 4 is a schematic representation of another aspect of the present invention showing a single phase superconducting fault current limiter interfaced by a transformer to a single phase alternating current generator.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

According to aspects of the present invention, a current in an alternating current generator, hereinafter, AC generator, may be limited to a predetermined maximum value by connecting a superconducting fault current limiter, hereinafter, SFCL, in series with an electrical circuit formed either between the generator and a neutral connection or between the generator and a corresponding load, During normal system operation, the SFCL operates in a superconducting mode and is substantially transparent to the distribution of electrical power, e.g., due to the near zero impedance of the SFCL while in superconducting mode and the resulting insubstantial voltage drop and corresponding power losses. Upon occurrence of a fault or other condition resulting in a current flowing through the SFCL that exceeds a previously determined design threshold value, the SFCL stops superconducting, forcing the current through a higher impedance, thereby limiting the current in the AC generator to a known maximum value.

According to an aspect of the present invention, the SFCL may be located at or about a generation facility of the corresponding AC generator and is thus proximate to the AC generator. In this fashion, the AC generator may be protected from electrical and/or physical damage resulting from a current overload such as that resulting from a fault condition, inadvertent out-of-phase synchronization, etc. For example, the SFCL may be connected to the neutral conductors of the AC generator between the AC generator and an associated neutral connection that provides a path to ground. In another exemplary arrangement, the SFCL may be connected to the main conductors of the AC generator between the AC generator and a transformer connected to a transmission line that carries power from an AC generating station to a corresponding load.

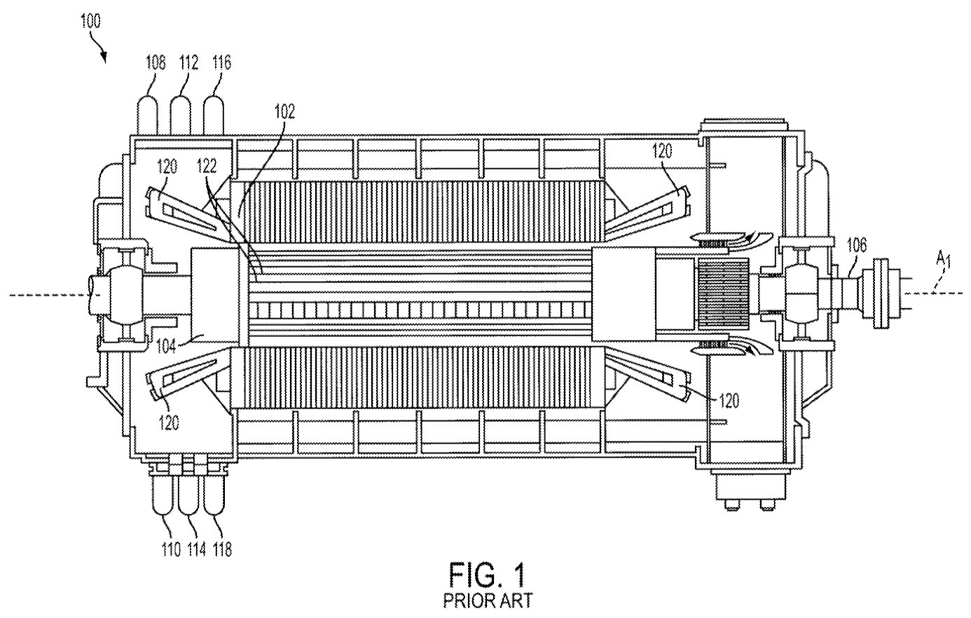

Referring now to the drawings and particularly to FIG. 1; an exemplary alternating current generator 100 for use in an electrical power generating facility is shown. The illustrated generator 100 is of a type used to generate three phase 60 Hz, alternating current, The generator includes a stator assembly 102 comprising three separate phase coils for generating three separate phases of alternating current, which are herein designated ØA, ØB and ØC. The illustrated stator assembly 102 is generally cylindrical in shape having a channel that passes through the stator assembly 102 along a longitudinal center axis A₁. A rotor assembly 104 is positioned within the channel of the stator assembly 102. The rotor assembly 104 comprises a cylindrical shaft 106 about which electrical conductors are arranged thus defining a coil for generating a magnetic field about the rotor assembly 104.

The rotor assembly 104 is coupled to a prime mover (not shown) such as a steam turbine or gas turbine engine, etc. that causes the rotor assembly 104 to rotate within the stator assembly 102. As the rotor assembly 104 rotates within the stator assembly 102, an electrical current is caused to flow in the rotor coil generating a rotating magnetic field within the stator assembly 104. The rotating magnetic field induces a voltage across the three phase coils of the stator assembly 102 causing a current to flow in the phase coils ØA, ØB and ØC.

In the illustrated generator 100, the first phase coil ØA terminates in a first end that is electrically coupled to a main connection 108 and a second end that is electrically coupled to a neutral connection 110. Similarly, the second phase coil ØB terminates in a first end that is electrically coupled to a main connection 112 and a second end that is electrically coupled to a neutral connection 114. Still further, the third phase coil ØC terminates in a first end that is electrically coupled to a main connection 116 and a second end that is electrically coupled to a neutral connection 118. The connections 108, 110, 112, 114, 116 and 118 are provided external to the generator 100 for connection of conductors thereto, and may be positioned at any suitable location.

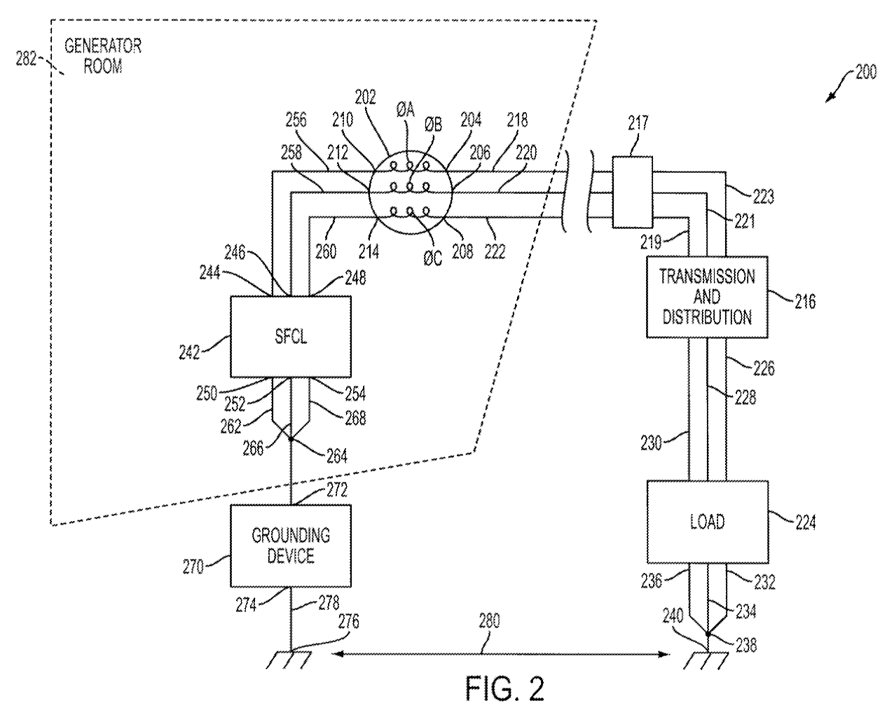

Referring now to FIG. 2, according to an aspect of the present invention, a three phase alternating current power generation system 200 is schematically illustrated in a commercial utility application. As illustrated, a three phase AC generator 202, such as is described with reference to FIG. 1, comprises three phase coils ØA, ØB and ØC, three mains connections 204, 206, 208 and three neutral connections 210, 212, 214. Phase coil OA has a first end electrically coupled to the main connection 204 and a second end electrically coupled to the neutral connection 210. Similarly, phase coil ØB has a first end electrically coupled to the main connection 206 and a second end electrically coupled to the neutral connection 212. Phase coil ØC has a first end electrically coupled to the main connection 208 and a second end electrically coupled to the neutral connection 214.

The generator 202 main connections 204, 206 and 208 are connected to a transformer 217 by conductors 218, 220 and 222 corresponding to phase coils OA, ØB and ØC, respectively. The transformer 217 is provided in order to adjust the voltage and current outputs produced by the generator 202 to values appropriate for connection to a transmission and distribution network 216. Conductors 219, 221 and 223 connect the transformer 217 to the transmission and distribution network 216. Devices (not shown) connected to the transmission and distribution network 216 consume electrical power supplied by the generator 202 for a variety of uses such as lighting, heating, air conditioning and the like, and constitute an alternating current load 224. The alternating current load 224, hereinafter, load, is connected to the transmission and distribution network 216 by conductors 226, 228 and 230, corresponding to electrical phases ØA, ØB and ØC, respectively, Conductors 232, 234 and 236 corresponding to electrical phase coils ØA, ØB and ØC, respectively, connect an opposite side of the load 224 together at a common load point 238 defining a Y connected alternating current load. The common load point 238 is connected to an earth ground at a point 240.

A SFCL 242 has a first set of connections 244, 246 and 248 and a second set of connections 250, 252 and 254. A conductor 256 electrically connects the neutral connection 210 of the generator 202 to the connection 244 of the SFCL 242, and thereby connects ØA to the connection 244 of the SFCL 242. Similarly, a conductor 258 electrically connects the neutral connection 212 of the generator 202 to the connection 246 of the SFCL 242, and thereby electrically connects ØB to the connection 246 of the SFCL 242. Additionally, a conductor 260 electrically connects the neutral connection 214 of the generator 202 to the connection 248 of the SFCL 242, and thereby electrically connects ØC to the connection 248 of the SFCL 242.

Furthermore, a conductor 262 electrically connects the connection 250 of the SFCL 242 to a common neutral point 264. Similarly, conductor 266 electrically connects the connection 252 of the SFCL 242 to the common neutral point 264 and conductor 268 electrically connects the connection 254 of the SFCL 242 to the common neutral point 264. In this fashion, the generator 202 is connected in the familiar Y arrangement as is typical of utility generation systems.

The common neutral point 264 may be connected to a grounding device 270 at a first connection 272. For example, the grounding device 270 may comprise a low power, high resistance device suitable for connecting the common neutral connection 264 of the three phase AC generator 202 to the earth ground. The grounding device 270 has a second connection 274 that is connected to the earth ground at point 276 by an earth conductor 278. The earth ground is indicated generally by reference numeral 280.

Locating the SFCL 242 between the generator 202 neutral connections 210, 212 and 214 and the common neutral point 264 that is connected to the earth ground 280 by the grounding device 270 allows the SFCL to operate substantially at an earth potential during normal operation of the system. Moreover, the SFCL 242 is located proximate to the generator 202 for example, within the generator room 282 at the generating facility, and may comprise individual SFCL devices for each of the neutral conductors 250, 252 and 254 or may be a combination three phase device.

During normal operation of the system, the current flowing through the phase coils ØA, ØB and ØC of the generator 202 is determined by the impedance of the transmission and distribution system 216 and the impedance of the load 224 but primarily by the impedance of the load 224. However, abnormal operation of the system may result, for example, due to failure of system components as well as naturally occurring phenomena and intentional or unintentional human activity, which can result in an unintended low impedance seen by the phase coils ØA, ØB and ØC of the generator 202. These situations, commonly called short circuits or faults, cause the current to rapidly rise in the affected generator coils ØA, ØB and ØC until protection equipment operates to protect the system components.

Generator short circuit currents in utility power generation generators can exceed 100,000 amperes within one half cycle of the occurrence of the fault. Such currents may result in electrical and mechanical stresses upon generator components well in excess of design parameters and may cause serious damage to both generator components and other components within the transmission and distribution network 216. For example, the rotating magnetic field within the generator 100 produces electromechanical forces acting upon the electrical conductors in the generator stator assembly 102 and the rotor assembly 104, see FIG. 1. As the magnetic field rotates, the forces apply rotational torques to the conductors that act to displace the conductors from their intended positions. These torques are generally proportional to the product of the generator voltage and current. Upon occurrence of a fault, the generator current increases to a value many times the operational non-faulted value causing the torques applied to the stator and rotor conductors to increase proportionally. In order to tolerate the torques produced by such fault currents, generator stator windings are braced and rotors are reinforced for short circuit duty.

However, by reducing the short circuit current using the SFCL 242 according to various aspects of the present invention, the torque applied to the generator shaft would be reduced by a like amount. For example, the air gap torque applied to a generator conductor resulting from a generator connected to an external impedance X_{EXT} is proportional to the torque at the terminals reduced by a factor F, where F=X″/(X″+X_{EXT}). Thus, the forces applied to a stator end winding 120, see FIG. 1, resulting from a fault condition, which are proportional to the product of the fault currents, could be reduced to 25% or less of the forces without the external impedance, X_{EXT}.

Another condition that will result in excessively high generator currents occurs when a generator is inadvertently connected in an out-of-phase condition with other generators operating in a networked power transmission and distribution system. Commercial power generation networks typically comprise multiple three phase generators operating in parallel, wherein all of the generators are synchronized to the network such that the current generated by each generator is of the same frequency and phase angle as that produced by the other parallel generators.

When an AC generator is first installed or an existing generator is returned to service after maintenance or repairs it must first be synchronized with respect to frequency and phase angle with the other parallel generators on the network before it can be connected to the system. When an AC generator is inadvertently connected to a network of operating generators in an out-of-phase condition, the generator is effectively short circuited by the other generators resulting in an out-of-phase synchronization current flowing through the generator phase coils ØA, ØB and ØC similar to those produced by the fault conditions described previously.

For example, the forces attributable to an out-of-phase synchronization is inversely proportional to the sum of X″+X_{SYS}+X_{EXT}, where X_{SYS} is the system reactance, including the main transformer, and X_{EXT} is the reactance attributable to the SECL 242. Thus, the forces applied to the stator end windings 120 resulting from a 180 degree out-of-phase synchronization would vary inversely as about the square of the sum of the reactances. For example, if the system reactance X_{SYS} is small and there is no external reactance X_{EXT}, the forces could significantly exceed those associated with a three phase fault occurring at the main connections of the generator. However, by reducing the short circuit current using the SFCL 242 according to various aspects of the present invention, the out-of-phase synchronization forces applied to the generator 202 can be reduced to fall within acceptable parameters despite the fault condition.

The SFCL 242 can be characterized as having two distinct operating modes. When the current flowing through the device is less than a predetermined design threshold current, the SFCL 242 operates in a superconducting mode having a relatively low, e.g., nearly zero impedance. In this mode the SFCL 242 adds essentially zero impedance to the circuit illustrated in FIG. 2, resulting in insubstantial voltage drop and corresponding power loss and is effectively transparent to the operation of the generation system.

Upon occurrence of a fault or other situation resulting in a current through the SFCL 242 that exceeds the predetermined design threshold current of the SFCL 242, the device ceases superconducting and switches to a high impedance mode effectively inserting a predetermined impedance between the affected generator phase coils ØA, ØB and ØC and the common neutral point 264. In this way the current in the affected generator phase coils ØA, ØB and ØC is limited to a predetermined maximum current defined by the design impedance of the SFCL 242 when operating in the high impedance mode.

According to aspects of the present invention, the design threshold current that causes the SFCL to transition from the superconducting mode to the high impedance mode may be determined based upon a maximum current that the generator phase coils ØA, ØB and ØC are designed to carry continuously.

In an exemplary configuration, the SFCL 242 is designed such that the design threshold current that causes the SFCL 242 to cease superconducting and switch to the high impedance mode is about 150 percent of a designed for maximum operating AC current of the generator 202 under normal loading conditions. However, other reasonable threshold current values may be specified.

As previously described, the torques applied to the conductors within the stator assembly 102 and the rotor assembly 104, see FIG. 1, are proportional to the currents flowing in the generator phase coils ØA, ØB and ØC. By limiting the currents flowing in the generator phase coils ØA, ØB and ØC, the SFCL 242 limits the torques applied to the conductors within the stator assembly 102 and rotor assembly 104 proportionally. In this fashion, a torque applied to the rotor shaft 106 by the prime mover (not shown) is limited to a predetermined maximum torque.

According to other aspects of the present invention, the design threshold current that causes the SFCL to transition from the superconducting mode to the high impedance mode may be determined based upon a maximum torque that the rotor shaft 106 is designed to tolerate. By limiting the torque applied to the generator rotor shaft 106, the generator may be protected from costly repairs and corresponding out-of-service time that might otherwise result should a fault condition or inadvertent out-of phase connection damage the rotor shaft 106.

In like manner, the design threshold current that causes the SFCL to transition from the superconducting mode to the high impedance mode may be determined based upon the maximum torque that may be applied to the stator end windings 120. By limiting the torque applied to the stator end windings 120, the generator may be protected from costly repairs and corresponding out-of-service time that might otherwise result should a fault condition or inadvertent out-of-phase connection damage the stator end windings 120.

Additionally, the design threshold current that causes the SFCL to transition from the superconducting mode to the high impedance mode may be determined based upon the maximum torque that may be applied to rotor conductors 122 within the rotor assembly 104. By limiting the torque that may be applied to the rotor conductors 122, the generator may be protected from costly repairs and corresponding out-of-service time that might otherwise result should a fault condition or inadvertent out-of-phase connection damage the rotor assembly 104.

Still further, the design of generators for new applications may take into account the reduced maximum torque applied to the rotor shaft 106 and the reduced maximum torque applied to the stator end windings 120 and the rotor conductors 122 that result from the various aspects of the present invention, in this fashion, it may be possible to design and manufacture generators for new applications at reduced cost and having improved reliability, smaller physical size, etc. For example, it may be possible to reduce the cost, and/or physical size of the structures conventionally used to brace generator stator end windings 120, to reinforce the rotor assembly 104 for short circuit duty and to mount the stator assembly 102 within the generator frame based upon the reduced maximum torques applied to the stator end windings 120 and the rotor shaft 106.

As previously described, inclusion of the SFCL 242 in proximity to the generator 202 limits the current flowing in the generator 202 to a predetermined maximum current. By limiting the current to a predetermined maximum current with the SFCL 242 it may be possible to replace conventional devices, such as circuit breakers and other current interrupting devices (not shown) between the generator 202 and the transformer 217 with a more simple and less expensive arrangement, such as by providing a disconnect switch (not shown). In this fashion, system maintenance may be reduced because the SCFL 242 will return to superconducting mode from its high impedance mode without human intervention once the current falls below the design threshold current whereas a typical conventional device, such as a circuit breaker must be manually reset.

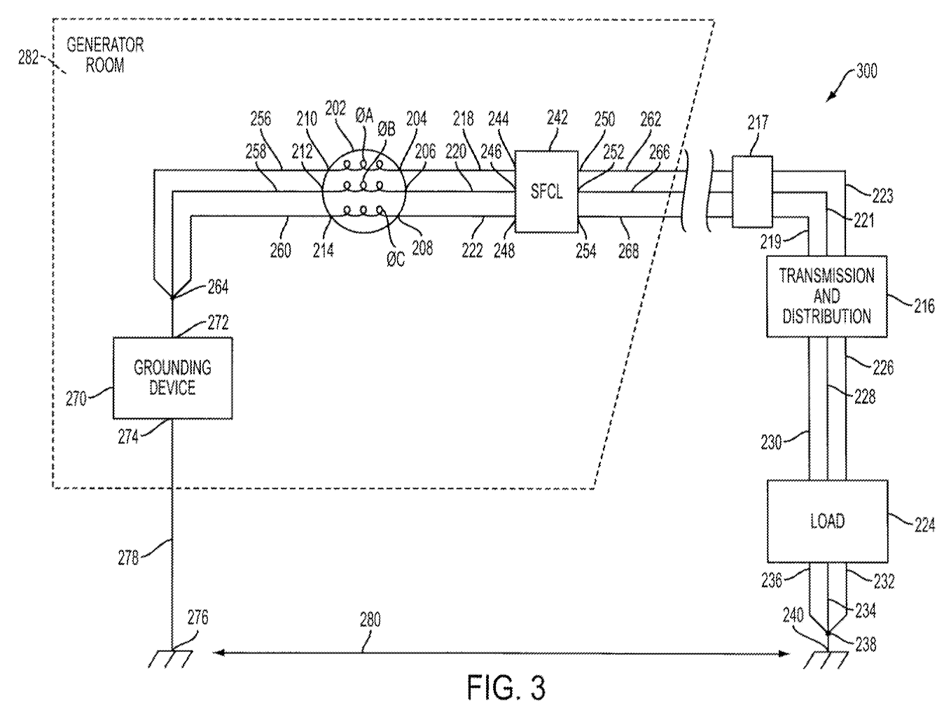

Referring now to FIG. 3, a three phase AC generation system in accordance with another aspect of the present invention is shown schematically, referred to generally by reference numeral 300. In the system illustrated the SFCL 242 has been relocated from the neutral side of the generator 202 to the load side of the generator 202. The description with regard to FIG. 3 is similar to that described previously with respect to FIG. 2 except as set out below.

As illustrated in FIG. 3, the three phase AC generator 202 main connections 204, 206 and 208 are connected to the SFCL first connections 244, 246 and 248 by conductors 218, 220 and 222, respectively. Specifically, a conductor 218 electrically connects the generator 202 main connection 208 to the SFCL first connection 244, thereby connecting the generator 202 phase coil ØA to the SFCL first connection 244. Similarly, a conductor 220 electrically connects the generator 202 main connection 206 to the SECL first connection 246, thereby connecting the generator phase coil ØB to the SFCL first connection 246. Additionally, a conductor 222 electrically connects the generator 202 main connection 208 to the SFCL first connection 248, thereby connecting the generator phase coil ØC to the SFCL first connection 248.

The SFCL second connections 250, 252 and 254 are connected to the transformer 217 by conductors 262, 266 and 268, respectively. The generator 202 neutral connections 210, 212 and 214 are connected together at the neutral common point 264 by conductors 256, 258 and 260, respectively, defining the familiar Y connection as set out in greater detail herein.

As previously described, inclusion of the SFCL 242 in proximity to the generator 202, for example, within the generator room 282 at the generating facility, limits the current flowing in the generator 202 to a predetermined maximum current. By limiting the current to a predetermined maximum current with the SFCL 242 in accordance with the present invention, it may be possible to replace a circuit breaker or other conventional current interrupting device(s) (not shown) between the generator 202 and the transformer 217 with a more simple and less expensive disconnect switch (not shown). Moreover, as noted above, the SFCL 242 may comprise individual SFCL devices for each of the main conductors 218, 228 and 222 or may be a combination three phase device.

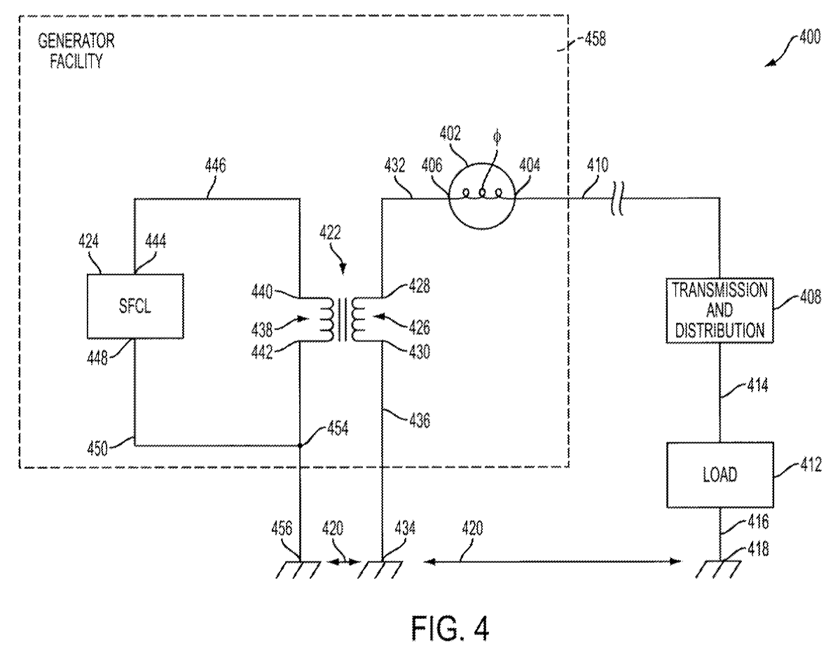

Referring now to FIG. 4, a single phase AC generation system in accordance with another aspect of the present invention is shown schematically, referred to generally by reference numeral 400. As illustrated, only a single phase is shown for clarity of discussion. However, in practice, the system 400 can be expanded to comprehend any number of phases, as will be described in greater detail herein.

A single phase AC generator 402 comprises a phase coil Ø, a main connection 404 and a neutral connection 406. The generator main connection 404 is connected to a transmission and distribution network 408 by a conductor 410. Devices (not shown) connected to the transmission and distribution network 408 consume electrical power supplied by the generator 402 for a variety of uses such as lighting, heating, air conditioning and the like, and constitute an alternating current load 412. The transmission and distribution network 408 is connected to the alternating current load 412, hereinafter, loads by a conductor 414. A conductor 416 connects an opposite side of the load 412 to an earth ground at a point 418. Earth is referred to generally by reference numerals 420.

A transformer 422 is provided to interface a SFCL 424 with the generator 402 neutral connection 406. The transformer 422 may be utilized, for example, to match the voltage/current requirements of the SFCL 424 to the voltage/current capabilities of the generator 402. As such, the specific ratio of primary and secondary windings of the transformer 402 will be determined by the specific implementation of the system 400 including the specific capabilities of the generator 402 and the SFCL 424.

As illustrated, the transformer 422 is provided to couple the SFCL 424 to the neutral connection of the generator 402 in order to reduce the current flowing in the SFCL 424 and allow the use of an SFCL designed to conduct a lower current than the current flowing in the generator 402 phase coil Ø.

The transformer 422 has a primary winding 426 having a first connection 428 and a second connection 430. The first connection 428 of the primary winding 426 is connected to the neutral connection 406 of the generator 402 by a conductor 432. The second connection 430 of the primary winding 426 is connected to the earth ground 420 at a point 434 by a conductor 436. During normal operation of the system 400, the current flowing through the phase coil Ø of the generator 402 is determined by the impedance of the transmission and distribution network 408 and the impedance of the load 412 but primarily by the impedance of the load 412. However, abnormal operation of the system may result, for example due to failure of system components as well as naturally occurring phenomena and intentional or unintentional human activity, which can result in an unintentional low impedance seen by the phase coil Ø of the generator 402. These situations, commonly called short circuits or faults, cause the current flowing in the generator 402 phase coil Ø to rapidly rise until protection equipment operates to protect the system components.

The transformer 422 also has a secondary winding 438 having a first connection 440 and a second connection 442. The secondary winding 438 first connection 440 is connected to a first connection 444 of the SFCL 424 by a conductor 446. A second connection 448 of the SFCL 424 is connected to the transformer 422 secondary winding 438 second connection 442 by a conductor 450. A conductor 452 may optionally connect the conductor 450 at a point such as point 454 to the earth ground 420 at a point 456.

The transformer 422 secondary winding 438 is magnetically coupled to the transformer 422 primary winding 426. Thus, as the alternating current produced by the generator 402 phase coil Ø flows in the primary winding 426 as previously described, a corresponding current is induced to flow in the secondary winding 438. This current also flows in the SFCL 424 connected in series with the transformer 422 secondary winding 438.

The SFCL 424 can be characterized as having two distinct operating modes. When a current flowing through the device is less than the predetermined design threshold current, the SFCL 424 operates in a superconducting mode having nearly zero impedance. In this mode the SFCL 424 comprises a low impedance, e.g., an essentially zero impedance, in series with the transformer 422 secondary winding 438 and a similar, effectively zero impedance is reflected to the transformer 422 primary winding 426. Thus, the transformer 422 primary winding 426 adds an insignificant impedance to the circuit comprising the generator 402 phase coil Ø, the transmission and distribution network 408, the load 412, the earth 420 and the transformer 422 primary winding 426 when the SFCL 424 is operating in the superconducting mode. The second mode is a high impedance mode as will be described in greater detail below.

Upon occurrence of a fault, the current flowing through the phase coil Ø of the generator 402 and the primary winding 426 of the transformer 422 increases rapidly, causing the current flowing through the transformer 422 secondary winding 438 and the SFCL 424 to increase proportionally. The transformer 422 is designed such that an alternating current induced to flow in the secondary winding 438 of the transformer 422 will increase to a value about equal to a predetermined design threshold current of the SFCL 424 as a current flowing in the primary winding 426 of the transformer 422 and the phase coil Ø of the generator 402 increases to a predetermined maximum generator current.

When the current flowing through the secondary winding 438 of the transformer 422 and the SFCL 424 exceeds the predetermined design threshold current of the SFCL 424, the SFCL 424 ceases superconducting and switches to its high impedance mode effectively inserting a known impedance in series with the secondary winding 438 of the transformer 422, resulting in a reduced current flowing in the secondary winding 438 of the transformer 422. The increased impedance seen by the secondary winding 438 of the transformer 422 is reflected to the primary winding 426 of the transformer 422, effectively inserting a known impedance in series with the phase coil Ø of the generator 402, the transmission and distribution network 408, the load 412 and the earth 420. In this way, the current in the phase coil Ø of the generator 402 is limited to a predetermined maximum current defined by the design impedance of the SFCL 424 when operating in the high impedance mode as reflected to the transformer 422 primary winding 426.

In an exemplary generation system 400, the SFCL 424 is designed such that the design threshold current that causes the SFCL 424 to cease superconducting and switch to the high impedance mode is a current that corresponds to about 150 percent of a designed-for maximum operating AC current of the generator 402 under normal loading conditions, but other reasonable threshold current values may be specified.

As previously described, the torques applied to the conductors within the stator and rotor assemblies of the generator 402 are proportional to the current flowing in the generator 402 phase coil Ø. By limiting the current flowing in the generator 402 phase coil Ø using the SFCL 424 according to various aspects of the present invention, the torques applied to the conductors within the stator assembly and rotor assembly of the generator 402 are limited proportionally. In this fashion, the torque applied to the rotor shaft of the generator 402 may be limited to a predetermined maximum torque.

As previously described, inclusion of the SFCL 424 in proximity to the generator 402, e.g., within or about the generator facility 458, in accordance with the system illustrated in FIG. 4, limits the current flowing in the generator 402 phase coil Ø to a predetermined maximum current. By limiting the current to a predetermined maximum current it may be possible to replace a circuit breaker or other conventional current interrupting device (not shown) between the generator 402 and the transmission and distribution network 408 with a relatively simple and inexpensive disconnect switch (not shown).

While the generation system 400 illustrated comprises a single phase AC generator 402, it will be readily apparent to those skilled in the art that the principles and concepts of the present invention apply equally well to generating systems having more than a single phase. For example, the generator 402 could comprise a multiple phase generator, the transmission and distribution network 408 could comprise a multiple phase transmission and distribution network, the load 412 could comprise a multiple phase load, the transformer 422 could comprise a multiple phase transformer and the SFCL 424 could comprise a multiple phase SFCL or a plurality of individual SFCL devices corresponding to a plurality of phases of the multiple phase transformer without departing from the spirit and scope of the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of limiting a current in an electrical generating system, comprising:
connecting an alternating current generator between an alternating current load and an earth conductor;
connecting a superconducting fault current limiter between said alternating current generator and one of said alternating current load or said earth conductor, wherein said superconducting fault current limiter is positioned proximate to said alternating current generator; and
configuring said superconducting fault current limiter to limit said current in said alternating current generator to a predetermined maximum current.

2. The method of claim 1, wherein:
said connecting an alternating current generator between an alternating current load and an earth conductor further comprises:
coupling said alternating current generator to said alternating current load through a transmission line; and
said connecting a superconducting fault current limiter between said alternating current generator and one of said alternating current load or said earth conductor further comprises;
connecting said superconducting fault current limiter between said alternating current generator and said transmission line.

3. The method of claim 1, wherein said connecting a superconducting fault current limiter between said alternating current generator and one of said alternating current load or said earth conductor further comprises:
connecting said superconducting fault current limiter between said alternating current generator and said earth conductor.

4. The method of claim 1, wherein said connecting a superconducting fault current limiter between said alternating current generator and one of said alternating current load or said earth conductor further comprises:
interfacing said superconducting fault current limiter to said alternating current generator through a transformer.

5. The method of claim 1, wherein said configuring said superconducting fault current limiter to limit said current in said alternating current generator to a predetermined maximum current further comprises:
setting said predetermined maximum current to a threshold that corresponds with a predetermined maximum shaft torque of said alternating current generator.

6. The method of claim 5, wherein said setting said predetermined maximum current to a threshold that corresponds with a predetermined maximum shaft torque of said alternating current generator further comprises:
setting said predetermined maximum shaft torque to correspond to at least one of an alternating current generator short circuit torque and an alternating current generator out-of-phase synchronization torque.

7. The method of claim 1, wherein said configuring said superconducting fault current limiter to limit said current in said alternating current generator to a predetermined maximum current further comprises:
setting said predetermined maximum current to a threshold that corresponds with a maximum force on at least one of an alternating current generator stator conductor and an alternating current generator rotor conductor.

8. The method of claim 1, wherein said alternating current generator comprises a three phase alternating current generator, said superconducting fault current limiter comprises a three phase superconducting fault current limiter and said connecting a superconducting fault current limiter between said alternating current generator and one of said alternating current load or said earth conductor further comprises:
connecting said three phase superconducting fault current limiter between said three phase alternating current generator and said earth conductor.

9. The method of claim 8, wherein said three phase alternating current generator comprises a three phase, Y connected alternating current generator and further comprising connecting a neutral grounding device between said three phase superconducting fault current limiter and said earth conductor.

10. The method of claim 1, wherein said connecting an alternating current generator between an alternating current load and an earth conductor further comprises:
coupling said alternating current generator to said alternating current load through a transmission line and connecting a disconnect switch between said alternating current generator and said transmission line.

11. A system to limit a current in an electrical generating system, comprising:
an alternating current generator;
a superconducting fault current limiter; and
a circuit, wherein said superconducting fault current limiter is positioned proximate to said alternating current generator and between said alternating current generator and one of an alternating current load or an earth conductor and said superconducting fault current limiter is configured to limit said current in said alternating current generator to a predetermined maximum current.

12. The system of claim 11, wherein said alternating current generator is coupled to said alternating current load through a transmission line and said superconducting fault Current limiter is positioned between said alternating current generator and said transmission line.

13. The system of claim 11, wherein said superconducting fault current limiter is positioned between said alternating current generator and said earth conductor.

14. The system of claim 11, wherein said superconducting fault current limiter is configured to limit a shaft torque of said alternating current generator to a predetermined maximum torque.

15. The system of claim 11, further comprising a transformer, wherein said superconducting fault current limiter is interfaced to said circuit through said transformer.

16. The system of claim 11, wherein said superconducting fault current limiter is configured to limit a maximum value of at least one of an alternating current generator short circuit torque and an alternating current generator out-of-phase synchronization torque.

17. The system of claim 11, wherein said superconducting fault current limiter is configured to limit a maximum force on at least one of an alternating current generator stator conductor and an alternating current generator rotor conductor.

18. The system of claim 11, wherein said alternating current generator comprises a three phase alternating current generator, said superconducting fault current limiter comprises a three phase superconducting fault current limiter connected between said three phase alternating current generator and said earth conductor and said circuit comprises a three phase circuit.

19. The system of claim 18 wherein said three phase alternating current generator comprises a three phase, Y connected alternating current generator and further comprising a neutral grounding device connected between said three phase superconducting fault current limiter and said earth conductor.

20. The system of claim 11, wherein said alternating current generator is coupled to said alternating current load through a transmission line and further comprising a disconnect switch connected between said alternating current generator and said transmission line.
